(19) United States
(12) Patent Application Publication
(10) Pub. No.: US 2025/0369539 A1
(43) Pub. Date: Dec. 4, 2025

(54) CONNECTION DEVICE WITH GEAR MECHANISM

(71) Applicant: BAUCONNECT GMBH & CO. KG, Monheim (DE)

(72) Inventor: Winfried Felber, Monheim (DE)

(21) Appl. No.: 19/217,255

(22) Filed: May 23, 2025

(30) Foreign Application Priority Data
May 29, 2024 (DE) 10 2024 115 105.6

(51) Int. Cl. F16L 5/10; F16L 15/08

(52) U.S. Cl. CPC F16L 5/10; F16L 15/08

(57) ABSTRACT

A connection device for connecting a pipe to a wall opening in a wall includes a connection unit that extends through the wall opening. The connection unit includes an accommodating region configured to accommodate the pipe, a first locking thread, and at least one stop configured for placement against a wall inner face. In addition, the connection unit includes a clamping unit supported against a wall outer face. The clamping unit includes a tool interface for introducing a torque and a clamping ring rotatable about a first rotational axis. The clamping ring includes a second locking thread corresponding to the first locking thread. The clamping unit further includes a gear mechanism interposed between the tool interface and the clamping ring.

### CROSS-REFERENCE TO RELATED APPLICATIONS

The present application is based upon and claims the right of priority to German Patent Application No. 10 2024 115 105.6, filed May 29, 2024, the disclosure of which is hereby incorporated by reference herein in its entirety for all purposes.

### FIELD OF THE INVENTION

The present subject matter relates to a connection device for connecting a pipe, in particular a confluent side pipe, to a wall opening in a wall, in particular a wall of a main pipe. The connection device includes a connection unit, which extends through the wall opening during use as intended and has, in particular in the region of a first end of the connection device, an accommodating region for accommodating the pipe, and a first locking thread, and which has, in particular in the region of a second end of the connection device, at least one stop for placement against a wall inner face. Furthermore, the connection device includes a clamping unit, which is to be supported against a wall outer face during use as intended and has, in particular in the region of the first end of the connection device, a tool interface for introducing a torque and a clamping ring, which is rotatable about a first rotational axis and has a second locking thread, which corresponds to the first locking thread, so that, when the clamping ring is rotated, the connection unit is axially movable relative to the clamping unit along a longitudinal axis of the device and/or the stop is pressable against the wall inner face.

### BACKGROUND OF THE INVENTION

DE 10 2012 014 956 A1 describes a device for fixing a pipe in an associated wall opening in a base part. The device includes a connection piece, which is fixable on the base part. This connection piece is supportable against the outer side of the main pipe. In addition, a clamping device is provided, which transmits tensile forces via a shape-variable structure. The disadvantage of this device is that a special tool is required for installation in order to be able to apply the high torques for installing the device. Without such a special tool, it is not possible to install the device.

### SUMMARY OF THE INVENTION

In various aspects, the problem(s) associated with the prior art is/are addressed by providing a connection device which can be installed using a standard tool.

Specifically, in various aspects, the problem(s) associated with the prior art is/are solved by a connection device having the features described and claimed herein. Advantageous or preferred embodiments are each the subject matter of one or more claims.

In one aspect, the present subject matter relates to a connection device for connecting a pipe, in particular a confluent side pipe, to a wall opening in a wall, in particular to a wall of a main pipe. The connection device includes a connection unit, which extends through the wall opening during use as intended. This enables a secure and tight connection of the side pipe to the main pipe. The connection device ensures a simple and efficient installation of the pipe at the wall opening. The connection unit includes, in particular in the region of a first end of the connection device, an accommodating region for accommodating the pipe, and a first locking thread. In the region of a second end of the connection device, the connection unit includes at least one stop for placement against an inner face of the wall. The accommodating region ensures that the pipe is stably fixed in the connection device. The first locking thread makes it possible to precisely and firmly brace the connection device. Moreover, the connection device includes a clamping unit, which is supported against a wall outer face, in particular during use as intended. The clamping unit has, in particular in the region of the first end of the connection device, a tool interface for introducing a torque. Furthermore, the clamping unit has, in particular in the region of the first end of the connection device, a clamping ring, which is rotatable about a first rotational axis and has a second locking thread, which corresponds to the first locking thread of the connection unit. The clamping unit effects a bracing of the connection device between the inner face and the outer face. By means of the tool interface, the necessary torque can be efficiently introduced, which facilitates installation.

Due to the two interlocked locking threads, the connection unit can be axially displaced relative to the clamping unit along a longitudinal axis of the device when the clamping ring is rotated. As a result, the stop is pressed against the wall inner face. The axial displaceability of the connection unit enables a firm contact pressure against the wall inner face. This improves the tightness and stability of the connection.

The clamping unit includes a gear mechanism, in particular a reduction gear mechanism. The gear mechanism is interposed between the tool interface and the clamping ring. As a result, the torque introduced via the tool interface is converted via the gear mechanism and only then transmitted onto the clamping ring. A reduction gear mechanism optimizes the force transmission. This contributes to precise and effortless installation. Accordingly, a low input torque at the torque interface can be converted via the gear mechanism into a higher output torque at the clamping ring. As a result, a considerably lower torque is required to install the connection device in comparison to the devices known from the prior art. This makes it possible to use standard tools such as inner polygonal wrenches or outer polygonal wrenches.

It is advantageous when the first rotational axis of the clamping ring is arranged coaxially with the longitudinal axis of the device. A coaxial arrangement of the rotational axis minimizes tension and ensures a uniform application of force. This improves the reliability of the connection and facilitates installation.

It is advantageous when the first locking thread is an external thread and the second locking thread is an internal thread. The combination of an external thread and an internal thread enables a secure and stable connection of the two components. This contributes to the durability of the connection.

Advantageously, the connection unit includes a connection piece. The connection piece acts as a stable and tight connection unit between the pipe and the connection device. The connection piece makes it possible to easily and precisely install the pipe.

It is advantageous when the connection piece has the accommodating region for accommodating the pipe. The accommodating region in the connection piece ensures that the pipe is firmly fixed and prevents slipping. This ensures a reliable and tight connection.

In an advantageous development of the present subject matter, a sealing element is located in the accommodating region. The sealing element provides additional sealing, which prevents liquids or gases from leaking.

In addition, it is advantageous when an internal extension thread for a nozzle extension is formed in the accommodating region. The internal extension thread makes it possible to flexibly adapt the length of the connection device. This increases the versatility and adaptability of the connection device to different requirements.

According to an advantageous development of the present subject matter, the first locking thread is formed on the connection piece, in particular on an outer periphery of the connection piece. The placement of the first locking thread on the outer periphery of the connection piece facilitates access and handling during installation. This contributes to faster and more efficient installation.

Advantageously, the connection unit includes a pull ring, which is preferably shape-variable, so that the pull ring can adapt to the contour (e.g., a concave contour) of the inner face of the wall.

In addition, it is advantageous when the pull ring includes a multitude of stops, which are preferably movable with respect to one another in the circumferential direction and/or the axial direction of the pull ring. This makes it possible to flexibly adapt the position of the stops in order to ensure an optimal fixation on the wall inner face. The movability of the stops contributes to the simple installation.

Advantageously, the connection piece and the pull ring are movable with respect to one another in the axial direction of the connection device. The axial movability between the connection piece and the pull ring facilitates the adaptation and the fine adjustment of the connection. This improves the handling and the assembly accuracy.

It is advantageous when the connection unit includes a coupling element, in particular a traction cable, which connects the connection piece and the pull ring to one another. The coupling element ensures a stable and reliable connection between the connection piece and the pull ring. This ensures a uniform transmission of force and a defined deformation of the pull ring during installation.

It is advantageous when the connection unit includes a rubber sleeve. The rubber sleeve enables a tight connection between the connection device and the wall opening. It is advantageous when the rubber sleeve is connected to the connection piece. The connection of the rubber sleeve to the connection piece ensures a stable and tight fixation. This improves the overall stability of the connection device.

Moreover, it is advantageous when the rubber sleeve is located on an outer periphery of the pull ring and/or on an outer periphery of the connection piece. This provides an additional sealing effect. The positioning of the rubber sleeve contributes to the durability and reliability of the connection.

It is advantageous when the connection unit includes an internal pipe, which is displaceable from an installation position into an operating position relative to the pull ring and/or to the connection piece along the longitudinal axis of the device. The internal pipe enables simple and precise installation and reliable fixation in the operating position. It is advantageous when the internal pipe includes an installation handle, which is located inside the internal pipe and/or is removable, for axial displacement into the operating position. The installation handle facilitates handling and the precise displacement of the internal pipe into the desired position. This improves the user friendliness and efficiency during installation. It is advantageous when the internal pipe, when in the operating position, presses the stops of the pull ring radially toward the outside, so that the stops engage behind and/or undercut the wall inner face in the region of the wall opening. By pressing the stops radially toward the outside, a stable and secure fixation at the wall inner face is ensured. This increases the stability and tightness of the overall connection.

Advantageously, the internal pipe, when in the operating position, is interlockingly connected, in particular latched, and/or fixed to the pull ring. The interlocking connection between the internal pipe and the pull ring ensures stable fixation and prevents an unintentional release.

Moreover, it is advantageous when the clamping unit includes a support element. Via the support element, the clamping unit, during use as intended, is preferably supportable against the wall outer face. The support element offers additional stability and support for the clamping unit, in particular during installation. This improves the reliability of the connection device.

In addition, it is advantageous when the support element, in particular in the region of the first end thereof facing away from the clamping ring, has a support face, via which the clamping unit is supportable against the wall outer face. The support face of the support element enables the forces to be uniformly distributed on the wall outer face. This prevents damage and increases the stability of the overall construction.

It is advantageous when the support element, in particular in the region of the second end thereof facing the clamping ring, lies against the clamping ring and/or includes a first bearing region for mounting the clamping ring. The support element being supported against the clamping ring improves the stability and reduces the movability of the clamping ring in undesired directions. The first bearing region ensures precise guidance and mounting of the clamping ring, which improves the functionality of the connection device.

Advantageously, the support element includes, in the first bearing region, a bearing face against which the clamping ring lies. The bearing face offers a defined contact face for the clamping ring and thus ensures stable mounting.

It is advantageous when the first bearing region includes a guide groove, which is preferably circular and/or arranged concentrically with the first rotational axis. The guide groove enables exact guidance of the clamping ring along the intended first rotational axis. This ensures a precise and smooth motion of the clamping ring.

Advantageously, the bearing face forms a groove base of the guide groove. The groove base offers a stable contact face for the clamping ring and prevents slipping. This contributes to the reliability and precision of the device.

It is advantageous when the clamping ring includes multiple bearing extensions, in particular on an end face facing the support element. By means of the bearing extensions, the friction between the clamping ring and the support element is reduced when the clamping ring is rotated. The bearing extensions minimize the contact face and thus reduce the friction, which enables easier rotation. Advantageously, as a result, the necessary input torque at the tool interface can be reduced.

Advantageously, adjacent bearing extensions are spaced apart from one another in the circumferential direction of the clamping ring. As a result, the contact face between the clamping ring and the support element can be reduced and, as a result, the friction arising during installation can be reduced.

It is advantageous when the bearing extensions interlockingly engage into the guide groove, so that the clamping ring is guided via the bearing extensions about the first rotational axis by the support element. The interlocking engagement of the bearing extensions into the guide groove ensures precise guidance and prevents the clamping ring from tilting. This ensures a smooth and reliable function.

In addition, it is advantageous when the free ends of the bearing extensions taper and/or the free ends of the bearing extensions are rounded in order to reduce the contact region and, as a result, the friction between the clamping ring and the support element. This facilitates the rotational movement and reduces the wear.

It is advantageous when the gear mechanism is a gear, in particular a spur gear. A gear, in particular a spur gear, ensures efficient force transmission and precise motion control. This improves the performance and reliability of the connection device.

It is advantageous when the gear mechanism includes at least one input gear, which is mounted rotatably about a second rotational axis. The rotatable input gear enables a flexible and efficient transmission of force in the gear mechanism. This contributes to the overall functionality and efficiency of the connection device.

Moreover, it is advantageous when the second rotational axis of the at least one input gear is aligned in parallel with the first rotational axis of the clamping ring and/or is spaced apart therefrom. The parallel alignment of the rotational axes enables a synchronized and efficient motion of the gears. This ensures a uniform transmission of force and reduces the friction in the gear mechanism.

It is advantageous when the at least one input gear has a first toothed section having a first toothing. The first toothed section ensures a precise and stable connection to a second toothed section of the clamping ring. This improves the efficiency and reliability of the gear mechanism.

It is advantageous when the gear mechanism includes multiple, in particular two, three, or four, input gears.

It is advantageous when the clamping ring has the second toothed section. Advantageously, the second toothed section has a second toothing, which in particular corresponds to the first toothing of the at least one input gear. The corresponding toothing between the clamping ring and the input gear ensure a frictionless and efficient transmission of force.

Advantageously, all teeth or only a few teeth of the second toothing, in particular every second tooth, are lengthened in the axial direction and form the bearing extensions. The axially lengthened teeth increase the stability.

It is advantageous when the second toothing of the clamping ring is formed on an outer periphery of the clamping ring.

Moreover, it is advantageous when the first toothing of the at least one input gear and/or the second toothing of the clamping ring is an external tooth system. External tooth systems enable force to be transmitted precisely and reliably between the components.

It is advantageous when the first toothing of the at least one input gear meshes (e.g., directly meshes) with and/or engages into the second toothing of the clamping ring. The direct meshing of the toothing ensures a frictionless and efficient transmission of force. Furthermore, the overall dimensions of the connection device can be reduced as a result.

It is advantageous when the at least one input gear indirectly meshes with and/or engages into the second toothing of the clamping ring.

Additionally or alternatively, it is advantageous when the at least one input gear is coupled to the clamping ring via at least one intermediate element, in particular an intermediate gear and/or an intermediate toothed belt.

Advantageously, the first toothed section of the at least one input gear has a smaller diameter in comparison to the second toothed section of the clamping ring. A smaller diameter of the first toothed section enables a higher gear ratio and thus a more effective force transmission.

It is advantageous when the first toothed section of the at least one input gear has, in particular in the region of the first tooth section end face thereof facing away from the support element, an axial tooth stop. The axial tooth stop prevents the toothing from becoming unintentionally displaced in the axial direction. Moreover, it is advantageous when the tooth stop is designed such that it prevents the second toothing of the clamping ring from slipping out of the first toothing of the input gear in the axial direction. This ensures a reliable and secure connection of the gears. As a result, the clamping ring can be fixed on the support element in the axial direction via the input gear.

It is advantageous when the at least one input gear has a bearing shaft section. The bearing shaft section offers additional guidance and stabilization of the input gear. This ensures a frictionless and reliable rotational movement of the input gear.

It is advantageous when the bearing shaft section is located on the side of a second tooth section end face of the first toothed section facing the support element. This enables stable mounting of the at least one input gear on the support element and improves the force transmission. The positioning of the bearing shaft section increases the efficiency and reliability of the gear mechanism.

Advantageously, the support element includes at least one second bearing region for rotatably mounting the at least one input gear. The at least one second bearing region ensures precise guidance and mounting of the at least one input gear.

It is advantageous when the support element includes, in the second bearing region, at least one mounting recess in which the bearing shaft section of the input gear is rotatably mounted. The mounting recess offers a defined receptacle for the bearing shaft section and thus ensures stable and precise mounting.

Moreover, it is advantageous when the at least one input gear is fixed (e.g., interlockingly fixed) in the axial direction of the second rotational axis and/or fastened in the mounting recess of the support element. The interlocking fixation prevents an unintentional displacement of the input gear in the axial direction.

It is advantageous when a latching mechanism is formed between the at least one input gear and the support element for axially fixing the input gear. The latching mechanism enables simple and precise fixation of the input gear in the axial direction.

Advantageously, the latching mechanism includes a latching groove, which in particular extends in the circumferential direction about the second rotational axis and/or is annular. The latching groove offers a defined positioning possibility for the latching mechanism and thus ensures precise fixation.

It is advantageous when the latching mechanism includes at least one latching extension which corresponds and/or engages into the latching groove. The latching extension ensures a secure and stable fixation of the input gear in the axial direction. This prevents unintentional displacement. Preferably, the latching extension is resilient and/or movable.

Moreover, it is advantageous when the latching groove is formed on the support element, in particular in a recess wall of the mounting recess, and the at least one latching extension is formed on the input gear. The formation of the latching groove in the recess wall enables precise guidance of the latching extension. This ensures a stable and secure fixation of the input gear.

It is advantageous when the at least one input gear has the at least one latching extension in the region of an end of the bearing shaft section facing away from the first toothed section. The positioning of the latching extension at the end of the bearing shaft section enables an effective and reliable fixation in the axial direction.

Advantageously, the at least one input gear includes the at least one tool interface. The tool interface makes it possible to easily and precisely use tools for operating the connection device. This improves handling and efficiency during installation.

It is advantageous when the at least one tool interface is connected to the first toothed section for conjoint rotation. The corotational connection ensures efficient force transmission.

Advantageously, the at least one tool interface is located in the region of the first tooth section end face. The arrangement of the tool interface on the tooth section end face enables simple access and facilitates handling. This improves the user friendliness and efficiency.

It is advantageous when the at least one tool interface is a standard tool interface, in particular an inner hexagon or an outer hexagon. A standard tool interface makes it possible to use common tools and thus simplifies installation. This increases the flexibility and practicality of the connection device.

Moreover, it is advantageous when the at least one tool interface is an inner polygon or an outer polygon. An inner polygon or an outer polygon offers a stable and secure connection to the tool, which improves force transmission. This contributes to the efficiency and reliability of the installation.

It is advantageous when the at least one input gear includes a first tool interface for clamping the connection device. Preferably, the first tool interface includes a limiting mechanism. With the limiting mechanism, only an established maximum torque can be transmitted via the first tool interface. The limiting mechanism prevents an overloading of the connection device and protects the components from damage. Moreover, optimal functionality of the connection device is ensured as a result when the connection device is braced in the wall opening with the optimal clamping force.

Advantageously, the limiting mechanism is designed such that it deploys at an established maximum target torque. The deployment at an established target torque ensures that the connection device is not overloaded. This protects the components and increases the reliability of the connection device.

It is advantageous when the limiting mechanism is designed such that, when it is deployed, the first tool interface is destroyed. As a result, the limiting mechanism can be very inexpensive.

Moreover, it is advantageous when the limiting mechanism includes a predetermined breaking point and/or a predetermined deformation region. A predetermined breaking point or a predetermined deformation region enables controlled destruction.

It is advantageous when the at least one input gear includes a second tool interface, in particular, for releasing or removing the connection device, via which a higher maximum torque is transmittable in comparison to the first tool interface. The second tool interface enables a secure and controlled release of the connection, even at higher torques. This facilitates the removal and increases the flexibility and user friendliness of the connection device.

Advantageously, a separating element is formed between the first tool interface and the second tool interface, which separating element is removable, in particular by destruction. The removable separating element enables a clear separation between the two tool interfaces. This increases the flexibility and user friendliness of the connection device.

It is advantageous when the first tool interface is formed by a first interface section and the second tool interface is formed by a second interface section of an inner polygonal recess.

Moreover, it is advantageous when the second interface section is located downstream from the first interface section. The downstream position of the second interface section enables a step-by-step application and improves the control over the installation process and the removal process. This contributes to secure and precise handling.

It is advantageous when the second interface section is longer than the first interface section, so that a greater torque is transmittable via the second interface section.

It is advantageous when a separating extension is located between the two interface sections, which separating extension projects into the inner polygonal recess and forms the separating element. The separating extension ensures a clear physical separation between the two interface sections and enables controlled destruction as necessary. This improves the safety and handling of the connection device.

Advantageously, the separating extension is removable by destruction, in particular by tapping a tool, in particular an inner polygonal wrench which corresponds to the first interface section, more deeply into the inner polygonal recess. Removing the separating extension by tapping a tool enables a targeted and controlled separation of the interfaces.

It is advantageous when the at least one input gear, in particular the first tool interface, the second tool interface, the first toothed section, the bearing shaft section, and/or the at least one latching extension, is monolithic and/or made of one material, in particular of a plastic. The monolithic and single-material design made of plastic ensures high strength and durability in combination with low weight and low manufacturing costs.

### BRIEF DESCRIPTION OF THE FIGURES

Further advantages of the present subject matter are described in the following exemplary embodiments. Wherein:

FIG. 1 shows a connection device with a gear mechanism in a perspective view,

FIG. 2 shows a schematic sectional view of the connection device from FIG. 1 mounted in a wall opening in a wall,

FIG. 3 shows a support element of a clamping unit of the connection device shown in FIGS. 1 and 2 in a perspective view,

FIG. 4 shows a clamping ring of the clamping unit of the connection device shown in FIGS. 1 and 2 in a perspective view,

FIG. 5 shows an input gear of the gear mechanism of the connection device shown in FIGS. 1 and 2 in a perspective view according to a first exemplary embodiment,

FIG. 6 shows the input gear of the gear mechanism of the connection device shown in FIGS. 1 and 2 in a head-side top view according to the first exemplary embodiment shown in FIG. 5,

FIG. 7 shows the input gear of the gear mechanism of the connection device shown in FIGS. 1 and 2 in a longitudinal section according to the first exemplary embodiment shown in FIGS. 5 and 6,

FIG. 8 shows the input gear of the gear mechanism of the connection device shown in FIGS. 1 and 2 in a head-side top view according to a second exemplary embodiment,

FIG. 9 shows the input gear of the gear mechanism of the connection device shown in FIGS. 1 and 2 in a longitudinal section according to the second exemplary embodiment shown in FIG. 8.

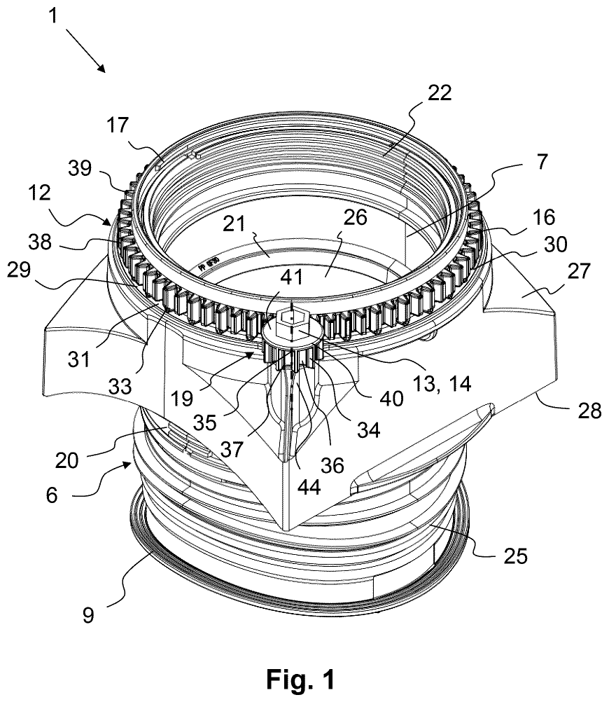

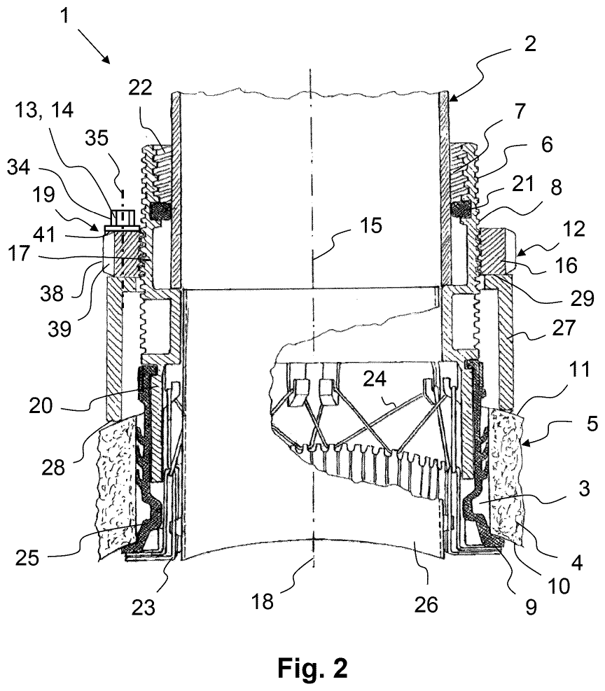

FIGS. 1 and 2 show a connection device 1, which is used to connect a pipe 2, in particular a confluent side pipe, to a wall opening 3 in a wall 4. The wall 4 can in particular be a wall of a main pipe 5, as is shown in FIG. 2. The connection device 1 includes a connection unit 6, which extends through the wall opening 3 during use as intended, as is shown in FIG. 2. In the region of a first end of the connection device 1, this connection unit 6 includes an accommodating region 7 for accommodating the pipe 2. The connection unit 6 also includes a first locking thread 8.

As is suggested by the exemplary embodiment, the connection unit 6 includes, in the region of a second end of the connection device 1, at least one stop 9, which is intended for placement against a wall inner face 10, as is shown in FIG. 2. In addition, the connection device 1 includes a clamping unit 12, which is supported against a wall outer face 11 during use as intended. This clamping unit 12 includes, in the region of the first end of the connection device 1, a tool interface 13, 14 via which a torque can be introduced for installing and/or removing the connection device 1.

According to FIGS. 1 and 2, the clamping unit 12 includes a clamping ring 16, which is rotatable about a first rotational axis 15. This clamping ring 16 includes, as is visible, in particular, in FIG. 4, a second locking thread 17, which corresponds to the first locking thread 8. When the clamping ring 16 is rotated, the connection unit 6 is axially movable relative to the clamping unit 12 along a longitudinal axis of the device 18. As a result, the stop 9 can be pressed against the wall inner face 10.

Moreover, it is apparent in FIG. 1 that the clamping unit 12 includes a gear mechanism 19. The gear mechanism 19 is located between the tool interface 13, 14 and the clamping ring 16 and/or is designed to transmit a torque. The first rotational axis 15 of the clamping ring 16 is arranged coaxially with the longitudinal axis of the device 18, which enables force to be efficiently transmitted.

The first locking thread 8 is an external thread and the second locking thread 17 is an internal thread. This thread arrangement ensures a secure connection of the connection unit 6 to the clamping unit 12.

According to FIGS. 1 and 2, the connection unit 6 also includes a connection piece 20. This connection piece 20 includes the accommodating region 7 for accommodating the pipe 2. This facilitates the insertion and fixation of the pipe 2 in the connection device 1 and ensures a stable connection. Moreover, a sealing element 21 is located in the accommodating region 7. This sealing element 21 ensures a reliable seal between the pipe 2 and the connection device 1. In addition, an internal extension thread 22, which is provided for a nozzle extension (not shown here), is formed in the accommodating region 7.

The first locking thread 8 is formed on the connection piece 20, in particular on an outer periphery of the connection piece 20. This enables an effective connection between the connection piece 20 and the clamping unit 12.

The connection unit 6 also includes a pull ring 23, as is shown in FIG. 2. This pull ring 23 is preferably shape-variable such that it can adapt to the contour (e.g., a concave contour) of the wall inner face 10 of the wall 4. The pull ring 23 includes a multitude of stops 9, which are movable with respect to one another in the circumferential direction and/or the axial direction of the pull ring 23. In addition, the connection piece 20 and the pull ring 23 are movable with respect to one another in the axial direction of the connection device 1. This enables the connection device 1 to be flexibly adapted to different wall thicknesses, wall shapes, and installation situations. In addition, the connection unit 6 includes a coupling element 24, in particular a traction cable, which connects the connection piece 20 and the pull ring 23 to one another. This coupling element 24 ensures a stable and secure connection of the two components.

Finally, the connection unit 6 includes a rubber sleeve 25. This rubber sleeve 25 is connected to the connection piece 20. The rubber sleeve 25 acts as a seal between the connection device 1 and the wall 4. In addition, as is shown in particular in FIG. 2, the rubber sleeve 25 is located on an outer periphery of the pull ring 23 and on an outer periphery of the connection piece 20. This arrangement of the rubber sleeve 25 ensures an effective seal.

According to FIG. 2, the connection unit 6 includes an internal pipe 26. The internal pipe 26 is movable relative to the pull ring 23 and to the connection piece 20 along the longitudinal axis of the device 18 from an installation position into the operating position shown in FIG. 2. The internal pipe 26 includes an installation handle (not shown in the present figures), which is located in the interior of the internal pipe and is removable, for axially moving the internal pipe into the operating position. The installation handle simplifies the handling and the installation of the internal pipe 26.

The internal pipe 26, when in the operating position, presses the stops 9 of the pull ring 23 radially toward the outside, as is shown in FIG. 2. This causes the stops 9 to undercut the wall inner face 10 in the region of the wall opening 3. This undercut enables the connection device 1 to be securely fixed in the wall opening 3. The internal pipe 26, when in the operating position, is interlockingly connected, in particular latched and/or fixed, to the pull ring 23. This interlocking connection ensures a stable and permanent positioning of the internal pipe 26.

Moreover, the clamping unit 12 includes a support element 27. The support element 27 makes it possible for the clamping unit 12 to be supported against the wall outer face 11 during use as intended. This contributes to the stability and safety of the overall connection device 1.

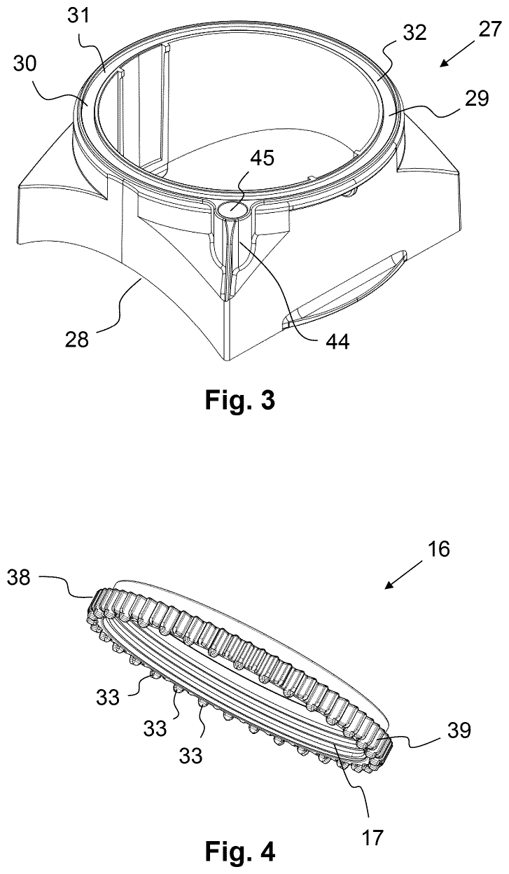

FIG. 3 shows a perspective detailed view of the support element 27 of the clamping unit 12 of the connection device 1 shown in FIGS. 1 and 2. The support element 27 includes a support face 28, in particular in the region of the first end of the support element facing away from the clamping ring 16. Via this support face 28, the clamping unit 12 is supportable against the wall outer face 11. This ensures that the clamping unit 12 is stably attached to the wall outer face 11. Furthermore, the support element 27 includes, in the region of the second end thereof facing the clamping ring 16, a first bearing region 29 for mounting the clamping ring 16. In this first bearing region 29, the clamping ring 16, which is shown in detail in FIG. 4, lies against the support element 27, which allows the clamping ring 16 to rotate with low friction.

The first bearing region 29 has a bearing face 30. This bearing face 30 forms a groove base 32 of the guide groove 31. The guide groove 31 is preferably circular and arranged concentrically with the first rotational axis 15. This ensures precise guidance of the clamping ring 16. The guide groove 31 and the bearing extension 33 are not shown in FIG. 2.

The clamping ring 16 includes, in particular on an end face facing the support element 27, multiple bearing extensions 33, which are readily apparent in particular in FIG. 4. These bearing extensions 33 reduce the friction between the clamping ring 16 and the support element 27 when the clamping ring 16 is rotated. Adjacent bearing extensions 33 are spaced apart from one another in the circumferential direction of the clamping ring 16 in order to allow a uniform distribution of the forces and a low-friction rotation. The bearing extensions 33 interlockingly engage into the guide groove 31. As a result, the clamping ring 16 is guided by the support element 27 about the first rotational axis 15. This guidance ensures precise and stable positioning of the clamping ring 16 during installation.

The free ends of the bearing extensions 33 taper and/or are rounded. This design of the free ends reduces the contact region and thus the friction between the clamping ring 16 and the support element 27. This contributes to a simpler installation of the connection device 1.

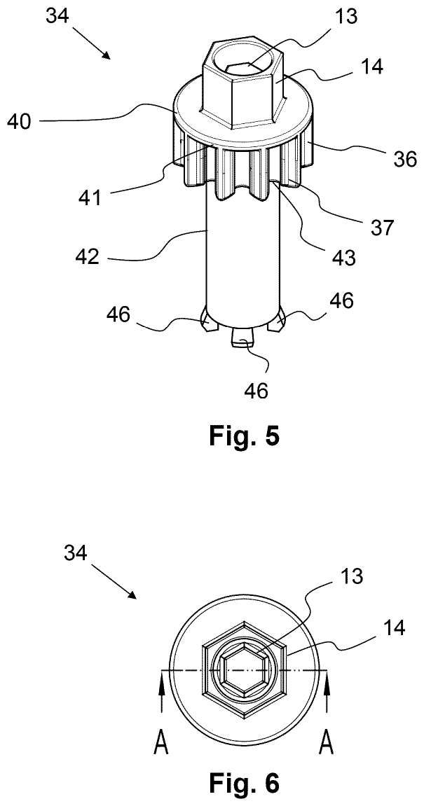

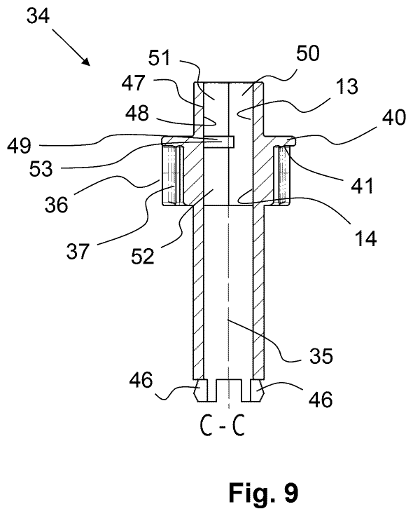

Moreover, it is apparent in particular in FIG. 1 that the gear mechanism 19 is in the form of a gear, in particular a spur gear. The gear mechanism 19 includes an input gear 34, which is mounted rotatably about a second rotational axis 35. A first exemplary embodiment of the input gear 34 is shown in FIGS. 5, 6, and 7. A second exemplary embodiment of the input gear 34 is shown in FIGS. 8 and 9. The second rotational axis 35 of the input gear 34 is aligned in parallel with the first rotational axis 15 of the clamping ring 16 and is spaced apart therefrom, in particular radially, as shown in FIGS. 1 and 2. This ensures an optimal transmission of force and an efficient rotational movement.

The input gear 34 includes a first toothed section 36 having a first toothing 37, as shown in FIG. 1. This first toothing 37 engages into the second toothing 39 of the clamping ring 16. The clamping ring 16 includes a second toothed section 38 having the second toothing 39, which is designed correspondingly, in particular, to the first toothing 37 of the input gear 34.

As is suggested by FIG. 4, one pair of the teeth of the second toothing 39, in particular every second tooth, is lengthened in the axial direction. The lengthening of the teeth form the bearing extensions 33. These bearing extensions 33 reduce the friction between the clamping ring 16 and the support element 27 when the clamping ring 16 is rotated. The second toothing 39 of the clamping ring 16 is formed on an outer periphery of the clamping ring 16, which enables a simple and efficient transmission of force. Furthermore, a highly compact design can be achieved as a result.

The first toothing 37 of the input gear 34 and the second toothing 39 of the clamping ring 16 are in the form of an external toothing, as shown in FIG. 1. This design ensures a direct and efficient transmission of force in the gear mechanism 19. The first toothing 37 of the input gear 34 directly meshes with the second toothing 39 of the clamping ring 16. The ensures a stable and secure connection, which enables a precise rotational movement.

The first toothed section 36 of the input gear 34 has a smaller diameter in comparison to the second toothed section 38 of the clamping ring 16. These different diameters effect the desired gear ratio, so that the connection device 1 can be reliably braced using a considerably lower input torque.

The first toothed section 36 of the input gear 34 has, in particular in the region of the first tooth section end face 40 of the first toothed section facing away from the support element 27, an axial tooth stop 41, as shown in FIGS. 1, 5, 7, and 9. This tooth stop 41 is designed such that it prevents the second toothing 39 of the clamping ring 16 from slipping out of the first toothing 37 of the input gear 34 in the axial direction.

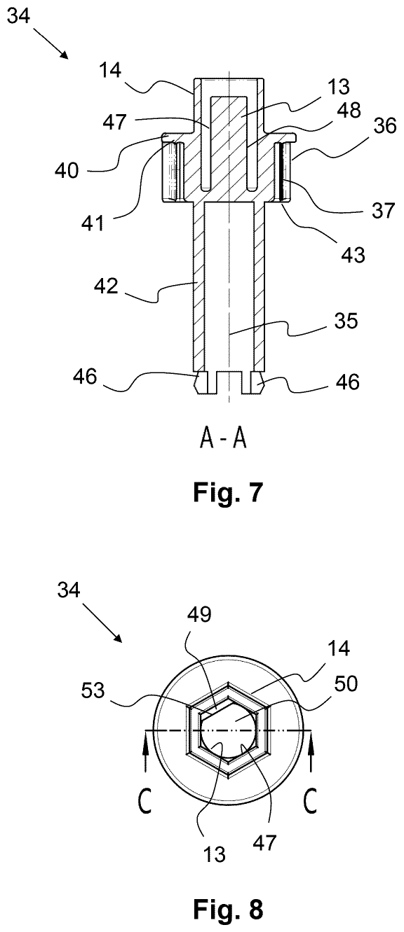

FIG. 5 shows the input gear 34 of the gear mechanism 19 of the connection device 1 shown in FIGS. 1 and 2 in a perspective view according to a first exemplary embodiment. FIG. 6 shows a head-side top view and FIG. 7 shows a longitudinal section of this input gear 34.

The input gear 34 has a bearing shaft section 42 as shown in FIG. 5. This bearing shaft section 42 is located on the side of a second tooth section end face 43 of the first toothed section 36 facing the support element 27. This ensures a stable and precise mounting of the input gear 34. According to FIGS. 1 and 3, the support element 27 has a second bearing region 44 for rotatably mounting the input gear 34. A mounting recess 45 is formed in the second bearing region 44 of the support element 27. The bearing shaft section 42 of the input gear 34 is mounted in this mounting recess 45 for rotation. This rotatable accommodation enables low-friction movement of the input gear 34.

The input gear 34 is fixed, in particular interlockingly fixed, in the axial direction of the second rotational axis 35 in the mounting recess 45 of the support element 27. This ensures precise positioning and prevents axial displacement of the input gear 34. A latching mechanism is formed between the input gear 34 and the support element 27 for axially fixing the input gear 34. This latching mechanism includes a latching groove (not visible in the present figures), which extends in particular in the circumferential direction about the second rotational axis 35. The latching groove is formed on the support element 27, in particular in a wall of the mounting recess 45. Furthermore, the latching mechanism includes at least one corresponding latching extension 46, which engages into the latching groove and is visible in FIGS. 5, 7, and 9. The at least one latching extension 46 is formed on the input gear 34.

In the region of an end of the bearing shaft section 42 facing away from the toothed section 36, the input gear 34 according to FIGS. 5, 7, and 9 includes the at least one latching extension 46. This positioning facilitates the installation of the input gear 34.

The input gear 34 also includes the at least one tool interface 13, 14. This tool interface 13, 14 is connected to the first toothed section 36 for conjoint rotation and is located in the region of the first tooth section end face 40. The at least one tool interface 13, 14 is in the form of a standard tool interface, which enables compatibility with different tools and simple handling. The at least one tool interface 13, 14 can be in the form of either an inner polygon or an outer polygon. This offers flexibility in the use of different tools for installing and removing the connection device 1.

According to the first exemplary embodiment shown in FIGS. 5, 6, and 7, the input gear 34 has a first tool interface 13 for clamping the connection device 1. This first tool interface 13 has a limiting mechanism 47. The limiting mechanism 47 is designed such that it deploys at an established maximum target torque. This limiting mechanism ensures that the connection device 1 is always tightened with the correct maximum torque during installation. As a result, a torque wrench is not needed at the installation site.

Moreover, the limiting mechanism 47 is designed such that, when it deploys, the first tool interface 13 is destroyed. This acts as an unambiguous signal that the maximum torque has been reached and prevents further loading of the connection device 1. Furthermore, the limiting mechanism 47 can therefore be structurally simple and inexpensive.

The limiting mechanism 47 includes a predetermined deformation region 48 as shown in FIG. 7. This predetermined deformation region 48 is specifically designed to deform and thus to deploy the limiting mechanism 47 when the target torque is exceeded.

In addition, the input gear 34 includes a second tool interface 14 for releasing the connection device 1. Via this second tool interface 14, a greater maximum torque can be transmitted in comparison to the first tool interface 13. The connection device 1 can be removed via the second tool interface 14.

FIGS. 8 and 9 show the input gear 34 of the gear mechanism 19 of the connection device 1 shown in FIGS. 1 and 2 in a head-side top view and in a longitudinal section according to a second exemplary embodiment. In the following description of the second exemplary embodiment shown in FIGS. 8 and 9, identical reference signs are used for features that are identical in terms of the design and/or mode of operation in comparison to the first embodiment shown in FIGS. 5, 6, and 7. Unless explained otherwise in the following, the embodiment and/or mode of operation thereof correspond(s) to the embodiment and/or mode of operation of the aforementioned features.

In contrast to the first exemplary embodiment, in the second exemplary embodiment shown in FIGS. 8 and 9, a separating element 49, which is removable, in particular by destruction, is formed between the first tool interface 13 and the second tool interface 14. This separating element 49 is used to separate the two tool interfaces 13, 14 and enables the targeted application of different torques.

According to FIG. 9, the first tool interface 13 is formed by a first interface section 51 and the second tool interface 14 is formed by a second interface section 52 of an inner polygonal recess 50. The second interface section 52 is located downstream from the first interface section 51. This means that the second interface section 52 projects farther into the inner polygonal recess 50 than the first interface section 51. The second interface section 52 is longer than the first interface section 51, so that a greater torque is transmittable by the second interface section. This different length makes it possible to adapt the transmitted forces in accordance with the requirements for installation and removal. The first interface section 51 includes the limiting mechanism 47 with the predetermined deformation region 48 of the limiting mechanism.

A separating extension 53 is located between the two interface sections 51, 52. This separating extension 53 projects into the inner polygonal recess 50 and forms the separating element 49. The separating extension 53 is removable by destruction, in particular by tapping a tool corresponding to the first interface section 51, in particular an inner polygonal key, further into the inner polygonal recess 50. This destruction of the separating extension 53 makes it possible to access the second tool interface 14 when the first tool interface 13 is destroyed, or deformed.

The input gear 34, in particular the first tool interface 13, the second tool interface 14, the first toothed section 36, the bearing shaft section 42, and/or the at least one latching extension 46, are monolithic and/or made of one material, in particular of a plastic. This one-piece construction provides high stability and durability of the input gear 34.

In an exemplary embodiment not shown here, the gear mechanism 19 can also include multiple input gears 34. These are then arranged on the support element 27 preferably spaced apart from each other in the circumferential direction of the first rotational axis 15 and/or are mounted on the support element for rotation.

### LIST OF REFERENCE CHARACTERS

1 connection device
2 pipe
3 wall opening
4 wall
5 main pipe
6 connection unit
7 accommodating region
8 first locking thread
9 stop
10 wall inner face
11 wall outer face
12 clamping unit
13 first tool interface
14 second tool interface
15 first rotational axis
16 clamping ring
17 second locking thread
18 longitudinal axis of the device
19 gear mechanism
20 connection piece
21 sealing element
22 internal extension thread
23 pull ring
24 coupling element
25 rubber sleeve
26 internal pipe
27 support element
28 support face
29 first bearing region
30 bearing face
31 guide groove
32 groove base
33 bearing extension
34 input gear
35 second rotational axis
36 first toothed section
37 first toothing
38 second toothed section
39 second toothing
40 first tooth section end face
41 tooth stop
42 bearing shaft section
43 second tooth section end face
44 second bearing region
45 mounting recess
latching extension
46 limiting mechanism
47 predetermined deformation region
48 separating element
49 inner polygonal recess
50 first interface section
51 second interface section
52 separating extension

1-15. (canceled)

16. A connection device for connecting a pipe to a wall opening in a wall, the connection device comprising:
a connection unit configured to extend through the wall opening, the connection unit including an accommodating region configured to accommodate the pipe, a first locking thread, and at least one stop configured for placement against a wall inner face; and
a clamping unit configured to be supported against a wall outer face, the clamping unit including a tool interface configured to introduce a torque and a clamping ring rotatable about a first rotational axis, the clamping ring including a second locking thread corresponding to the first locking thread,
wherein the clamping unit further comprises a gear mechanism interposed between the tool interface and the clamping ring.

17. The connection device of claim 16, wherein the gear mechanism is a reduction gear mechanism.

18. The connection device of claim 16, wherein the gear mechanism is a gear.

19. The connection device of claim 18, wherein the gear is a spur gear.

20. The connection device of claim 16, wherein the gear mechanism includes an input gear that is mounted rotatably about a second rotational axis, wherein the second rotational axis of the input gear is aligned in parallel with the first rotational axis of the clamping ring and/or is spaced apart therefrom.

21. The connection device claim 20, wherein the input gear comprises a first toothed section having a first toothing, and wherein the clamping ring includes a second toothed section having a second toothing, the second toothing being designed correspondingly to the first toothing (37) of the input gear (34).

22. The connection device of claim 21, wherein the first toothing of the input gear directly meshes with the second toothing of the clamping ring and/or wherein the first toothed section of the input gear has a smaller diameter in comparison to the second toothed section of the clamping ring.

23. The connection device of claim 16, wherein the clamping unit comprises a support element via which the clamping unit is supportable against the wall outer face.

24. The connection device of claim 23, wherein the support element comprises a first bearing region for mounting the clamping ring and/or a second bearing region for rotatably mounting the input gear.

25. The connection device of claim 24, wherein the first bearing region comprises a guide groove that is circular and/or is arranged concentrically with the first rotational axis.

26. The connection device of claim 23, wherein the clamping ring comprises, in particular on an end face facing the support element, multiple bearing extensions, adjacent bearing extensions of the multiple bearing extensions being spaced apart from one another in a circumferential direction of the clamping ring, and/or wherein the bearing extensions interlockingly engage into a guide groove of the support element.

27. The connection device of claim 26, wherein free ends of the bearing extensions taper and/or the free ends of the bearing extensions are rounded.

28. The connection device of claim 16, wherein the gear mechanism includes an input gear, the input gear including at least one tool interface.

29. The connection device of claim 28, wherein the at least one tool interface comprises a first tool interface for clamping the connection device, the first tool interface including a limiting mechanism.

30. The connection device of claim 29, wherein the limiting mechanism is configured such that it deploys at an established maximum target torque and/or destroys the first tool interface when deployed.

31. The connection device of claim 29, wherein the limiting mechanism comprises a predetermined breaking point and/or a predetermined deformation region.

32. The connection device of claim 29, wherein the at least one tool interface further includes a second tool interface for releasing the connection device, via which a greater maximum torque is transmittable in comparison to the first tool interface.

33. The connection device of claim 32, further comprising a separating element formed between the first tool interface and the second tool interface the separating element being removable.
